(19) United States
(12) Patent Application Publication
(10) Pub. No.: US 2010/0290677 A1
(43) Pub. Date: Nov. 18, 2010

(54) Facial and/or Body Recognition with Improved Accuracy

(76) Inventor: John Kwan, Santa Clara, CA (US)

Correspondence Address: GREGORY SMITH & ASSOCIATES, 3900 NEWPARK MALL ROAD, 3RD FLOOR, NEWARK, CA, 94560, US

(21) Appl. No.: 12/779,920

(22) Filed: May 13, 2010

Related U.S. Application Data
(60) Provisional application No. 61/177,983, filed on May 13, 2009.

(51) Int. Cl. G06K 9/00; G06F 17/30

(52) U.S. Cl. 382/118; 707/758

(57) ABSTRACT

Processors are disclosed configured to perform one or more of the following: assess at least one image containing an item for identification and a reference object to at least partly create an object schematic, and/or manage a list of object cells containing object schematics, and/or search the object cell list for matches to a second object schematic of an unknown person to create a list of possible matched persons. The object schematics include realistic parameters that may be realistic distances and/or positions. The object schematic, the list of object cells, and the list of possible matched persons are all products of various methods. The apparatus further includes removable memories and/or servers configured to deliver programs, installation packages and/or Finite State Machine configuration packages.

### CROSS REFERENCE TO RELATED PATENT APPLICATIONS

This application claims priority to Provisional Patent Application No. 61/177,983, entitled “Method and Apparatus for Improved Accuracy in Facial Recognition and/or Body Recognition” filed May 13, 2009 for John Kwan, and is incorporated herein by reference in its entirety.

### TECHNICAL FIELD

This invention refers to the automated recognition of human faces and/or bodies based upon object schematics of items for identification, where the object schematics contain realistic feature parameters that may include one or more realistic, rather than proportional, positions and/or distances.

### BACKGROUND OF THE INVENTION

Facial Recognition technology is a technology by which a machine such as a computer can take one or more digital photographs, scanned photographs, video or movies of an unknown person's face and or body and, through calculations, find one or more candidate person or people from a stored database of photos of known people and figure out the most probable identity of the unknown person.

The current technology relies on locating key points on a person's body such as the centers or corners of eyes, edge of their mouths, tips of their ears, joint of their jaws, shoulder joints, elbows, etc. and formulate a geometric shape to represent the person. When the geometric shape is formed from the elements of a face it is called a Face Print. When the geometric shape is formed from the elements of the body it is called a Body Print.

When matching the unknown face to a known set of candidate faces the relative geometric angles, lengths of various line connector segments, etc. are applied to compare the face in one photograph, scanned photograph, video or movies to those of faces in other such recordings. The relative probability of a match is based on the similarity of the Face Print calculated for one set of recordings when compared to one or more other set of recordings. Allowance is given for some possible joint movement such as the possible movement of the eyes, jaw, etc.

When matching a Body Print in one recording to another a similar process takes place except that allowance is given to the possible joint movements given knowledge of the body's constrains or degrees of movements possible for various joints.

When similar matches are made for animals instead of humans adjustments are made to take into account the relative degrees of freedom of various animal joints compared to human joints.

Even with all the forgoing, the current state-of-the-art is still not useful in a practical sense because false positives (an erroneous match between Face Print of one person with a photograph of a different person) is often very high. Often the error rate is so high that this Facial Matching or Body Matching results are completely useless in actual practical use. Basically, if a 5 foot tall person has the same relative body or facial distances and positions as a 6 foot 6 inch tall person a match may be declared even though these are obviously different people. The inverse problem, false negatives, is also devastating since that may allow a criminal to escape detection.

What is needed is a technique to greatly improve the results such that erroneous matches are reduced to a point that the matching results are actually useful. A method to correctly scale the actual, real world, sizes of the Facial or Body features and positions in addition to the existing Facial or Body matching methods will greatly improve the matching results and greatly reduce the error rate.

This type of technology has many implications such as improved tools for law enforcement to better aid in the protection of the public.

### SUMMARY OF THE INVENTION

The invention discloses and claims the creation and use of object schematics including realistic feature parameters that may include one or more realistic, rather than proportional, positions and/or distances. These object schematics are created based upon assessing at least one image including at least one item for identification and one or more reference objects of known realistic distance and/or position. The item may include a human face and/or a human body. The object schematics may be used to manage a list of object cells that each include at least one object schematic and personal information. The list may be searched based upon another object schematic of an unknown person to create a list of possible matched persons with greatly reduced false positive and false negative matches, because the matching is based upon the realistic feature parameters rather than proportional parameters. For example, it is far less probable that a face ten inches high will match a face 12 inches high.

The apparatus may include at least one processor configured to perform one or more of the following: assess the image to at least partly create the object schematic, and/or use the object schematic to manage the list of object cells, and/or search the object cell list for matches to the unknown person's object schematic to create the list of possible matched persons.

The processor(s) may including mean for performing operations, any of which may include one or more instances of Finite State Machines (FSM), computers, computer accessible memories, removable memories and servers. The memories and servers may include program systems, installation packages and/or FSM packages to configure the FSM.

The object schematic, the list of object cells, and the list of possible matched persons are all products of various steps of the methods of this invention. Each incorporate real world position and/or distance that serve to reduce false matches due to similarly proportioned, but distinctly sized features. These real world elements serve to improve homeland security, identification of children in crowds, criminals and terrorists possibly intent upon damaging the world around them, as well as aid in the identification of missing persons and victims of disasters.

### BRIEF DESCRIPTION OF DRAWINGS

FIG. 1 shows examples of some embodiments of apparatus of the invention, including a first processor configured to assess at least one image of an item for identification and a reference object of known size to at least partly create an object schematic. A second processor may be configured to maintain/update a list of object cells, each comprising at least one instance of the object schematic and personal data. And a third processor may be configured to search the list of object cells based upon the object schematic of an unknown person to at least partly create a list of possible matched persons. Note that in some other embodiments, all the shown processors may be implemented on a single processor.

FIG. 2 shows some of an example of some possible steps involved in analyzing the example scaled item of FIG. 1 with an example feature parameter list possibly using feature parameters that may identify a recognized feature, such as the eye, and may include one or more realistic parameters of the recognized feature.

FIG. 3 shows a second example image including more than one reference object and the item for identification includes both a human face and a human body.

FIG. 4 shows some details of various images that may be used with the embodiments of the apparatus.

FIG. 5 shows an example of a facial feature list that may be used to identify the recognized feature found in the feature parameter of FIG. 2. The feature parameter may include one or more realistic parameters that may include real world positions and/or distances.

FIG. 6 shows an example of a body feature list that may be used to identify the recognized feature found in the human body of FIG. 3.

FIG. 7 shows an example of the parameter list may include the positions shown in FIG. 2 as well as other positions and distances in two and three dimensions. Some of the parameters may be derived from other parameters.

FIG. 8 shows the object cell list containing object cells for at least one of criminals, employees, terrorists, school children, disaster victims, and/or missing persons.

FIG. 9 shows some details of a number of embodiments of the apparatus.

FIGS. 10 to 13 show some flowcharts of various methods of at least partly assessing the images, and/or managing the list of object cells, and/or at least partly generating the list of possible matched persons as first shown in FIG. 1.

FIGS. 14 and 15 show some details of the use of multiple images 20 that may provide a scaled item 26 in three dimensions.

### DETAILED DESCRIPTION OF DRAWINGS

This invention refers to the automated recognition of human faces and/or bodies based upon object schematics of items for identification, where the object schematics contain realistic feature parameters that may include one or more realistic, rather than proportional, positions and/or distances. The creation and use of the object schematics are disclosed and claimed.

These object schematics are created based upon assessing at least one image including at least one item for identification and one or more reference objects of known realistic distance and/or position. The item may include a human face and/or a human body. The object schematics may be used to manage a list of object cells that each include at least one object schematic and personal information. The list may be searched based upon another object schematic of an unknown person to create a list of possible matched persons with greatly reduced false positive and false negative matches, because the matching is based upon the realistic feature parameters rather than proportional parameters. For example, it is far less probable that a face ten inches high will match a face 12 inches high.

Given that there are several embodiments of the apparatus and method being disclosed and claimed, the detailed description will start by walking through the overall processes and the products of those processes. The apparatus is then discussed in terms of a number of components that may included in various implementations. A detailed discussion of the processes implemented as program system components of the apparatus follows. Lastly, there is a brief discussion regarding using multiple images to create object schematics in three dimensions.

The apparatus may include at least one processor configured to assess at least one image containing the item and the reference object to at least partly create the object schematic, and/or manage the list of object cells containing object schematics, and/or search the object cell list for matches to the unknown person's object schematic to create the list of possible matched persons.

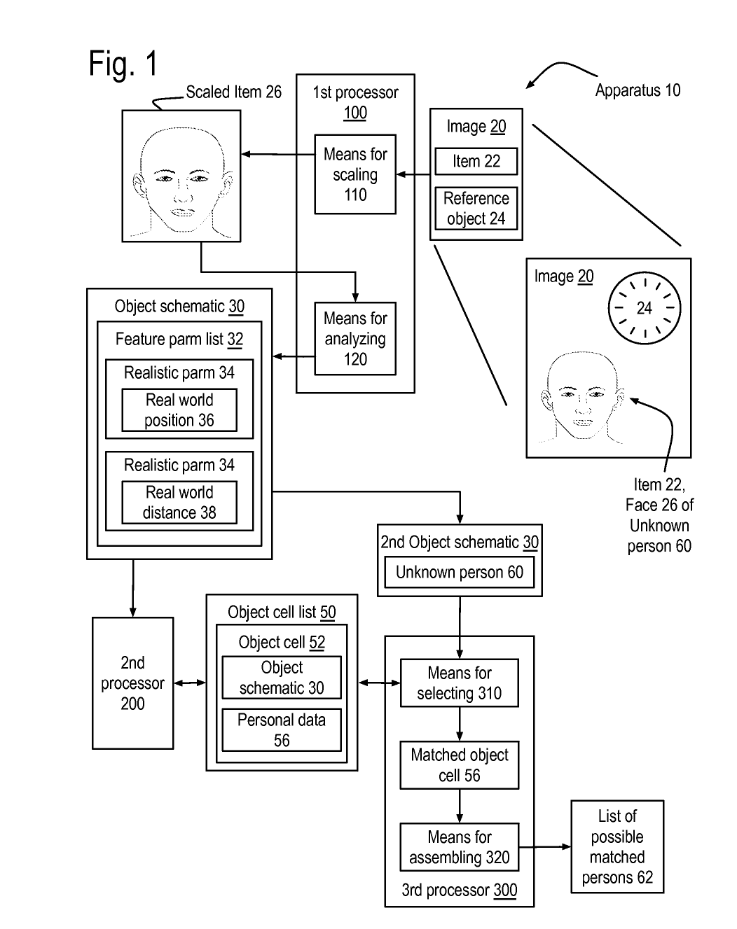

FIG. 1 shows examples of some embodiments of apparatus of the invention. While there are situations such as disasters in remote regions or with limited communications where a single processor may be used to perform all these operations, to simplify the discussion, three processors will be referred to. The first processor 100 may be configured to assess at least one image 20 of an item 22 and a reference object 24 of known size to at least partly create an object schematic 30 including at least one read world distance 32 and a list 34 of at least two feature parameters configured to be translated into realistic parameters. The second processor 200 may be configured to manage a list 50 of object cells 52, each comprising at least one instance of the object schematic 30 and personal data 56. And the third processor 300 may be configured to search the list 50 of object cells 52 based upon the object schematic of an unknown person 60 to at least partly create a list of possible matched persons 62. By way of example, the item 22 may include a human face 26 of the unknown person and the reference object 24 may be an everyday item such as a clock mounted on a wall, a door frame with its hinges, a collection of scaled lines or positioned dots, a placard and/or a sign.

In some situations, the first processor 100 may be implemented as means 110 for scaling the item 22 by the reference object 24 to create a scaled item 26 and/or means 120 for analyzing the scaled item to create the object schematic 30. These means may be made and/or operated separately from each other.

The object schematic 30 is a product of assessing the image 20, and more particularly of analyzing 120 the scaled item 26. The use of the object schematic rather than an object print greatly reduces the error rate of any Facial Recognition or Body Recognition technique applied to a database of object schematics, such as the object cell list 50, in that the distances and/or positions of the parameter list 34 are now real world accurate and false matches of similar relatively proportioned faces are reduced.

Similarly, the third processor 300 may include means 310 for selecting one of the object cells 52 from the object cell list 50 having a parameter match with at least one of the features in both the second object schematic 30 and the object cell to create a matched object cell 56 and/or means 320 for assembling the matched object cells to create the list 62 of the possible matched persons.

Scaling 110 the image 20 may involve some or all of the following details:
If the reference object 24 is at the same distance from a camera 70 (shown in FIGS. 14 and 15) as the item 22 for identification, the reference object can be used directly to scale the item requiring identification. However, if the reference object is not in the same plane as the item for identification then perspective distortion is to be used to determine the relative distance between the lens to the reference object and the lens to the item for identification.
In the case of law enforcement work the vast majority of the time a reference object 24 is in or close enough to the plane of the item 22 for identification, and the reference object may actually be in the plane of the item for identification. For example, in the case of mug shots where a person being arrested is asked to hold up a plaque with their name and booking number and the police department name, the plaque itself is of known size and can be used as a reference item to scale the suspect's facial schematic. The same can be the of a similar situation where a suspect or unknown person 60 stands in front of a vertical scale on a wall or in a doorway that marks the height of the person as shown in FIG. 3 below. In that case the wall markings itself is the reference object.
In other situations such as identification photos 20 for use as drivers' license photos, employee photos for a company's identification cards, etc. reference objects 24 of known size can be introduced into the photo as part of the photography procedure.
The sizing of the photo, video or film once a reference object 24 is visible is readily performed. There are a number of methods to do this. A few will be listed here but this list is not meant to be exhaustive.
If a ruler, plaque, wall markings, etc. are visible one method to scale the object is to display the photo as an image 20 on a computer 222 and simply have the user click on two points in the digital photo with the computer pointing device. These points may be points on the ruler, the ends of the plaque, etc. The computer will detect the actual pixels clicked on then ask the user the actual real world distance between the two points clicked. Once the user provides this, the computer can calculate the actual size of each pixel in the digital photo in real world units using these two pieces of information.
If the reference object 24 was provided by the photographer, special markings can be placed on the reference object ahead of time. These special visual objects can be designed so that the computer software can scan the digital photograph and recognize them automatically without human intervention. Since the reference object is manufactured to certain specifications the actual real world distance between the targets is known so that the computer 222 can also compute the size of pixels in real world units without human intervention.
In the case of the image 20 as a movie film or video, scaling can be achieved if there is motion visible in the view of the camera 70. For example if in the background a car is passing in the street and the distance traveled in a certain number of frames of the video by a car can be used to calculate the size of pixels in the frame of the car. Since on most streets cars travel at close to the speed limit and the video or film frame rate is known this gives us a measurement of size and can be used, along with what is known about the physical makeup of the scene to size the person visible in the video and give us scaled item 26.
If the actual location setup is known the people 22 and/or 24 and/or 26 in the photo or video image 20 can be scaled to create the scaled item 26. For example, in the case of casino video the size of a roulette wheel, tables and chairs visible in the photo or video are all known, as is their relative distance from the mounted camera 70. Using all this information, the size of a pixel in real world units for people at various distances from the camera (or different locations within the view of the camera) may be pre-calculated and use this scaling data to give the scaled item 26.

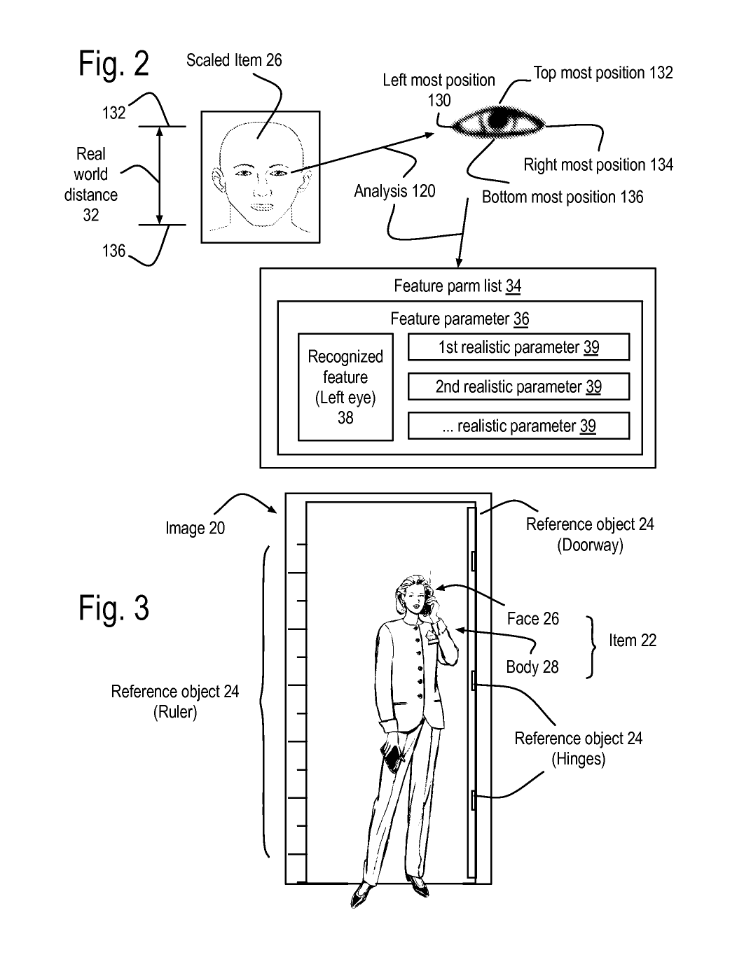

FIG. 2 shows some of an example of some possible steps involved in analyzing 120 the example scaled item 26 of FIG. 1, where the real world distance 32 may approximate the distance between a top most position 132 and a bottom most position 136 of a human face as the recognized feature of the scaled item. Analyzing may also extract a feature to create an feature parameter 36, possibly identified 38 as the left eye, possibly with two or more feature parameters 39 such as a left most position 130, the top most position 132, a right most position 134 and the bottom most position 136.

These real world positions 130, 132, 134, and 136 may be calculated from an origin located at a midpoint position that may be at the intersection of the central tall axis and a central wide axis of the scaled item 26. These parameters may also include the height of the human face in the tall axis and the width of them in the wide axis.

FIG. 3 shows a second example image 20 including more than one reference object 24 and the item 22 includes both a human face 26 and a human body 28. The reference objects include a doorway, hinges and a ruler painted on the doorway, all of which may have known realistic parameters. In other embodiments, the item 22 may be an animal or other item besides the human body and/or human face.

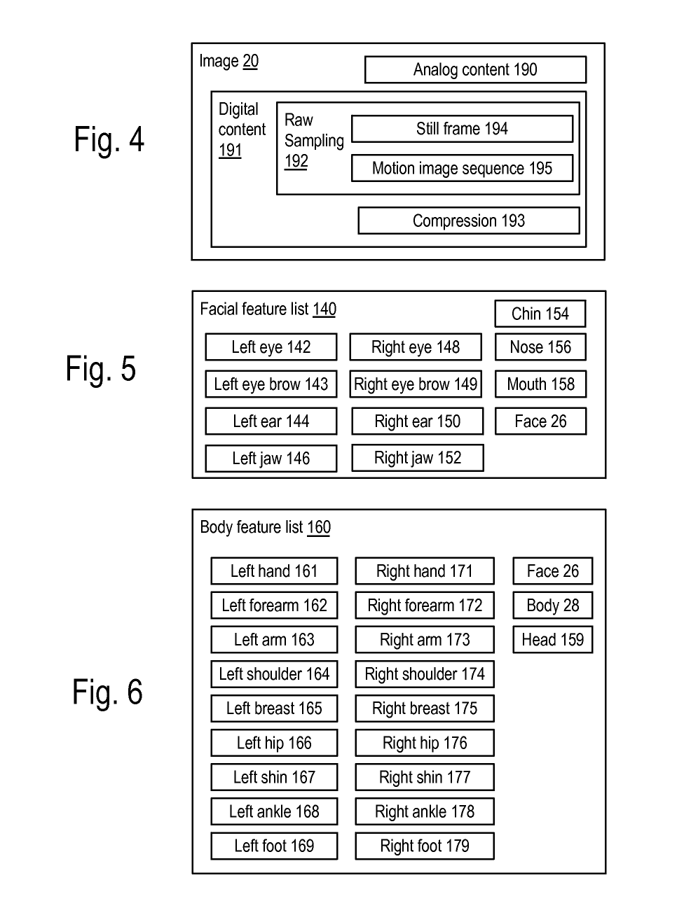

FIG. 4 shows some details of various images 20 that may be used with the embodiments of the apparatus 10. The image may include analog content 190, such as a home movie or a video tape. The image may include digital content 191 that may further include at least one raw sampling 192 and/or a compression 193 of the raw sampling. The raw sampling may further include at least one still frame 194 and/or at least one motion image sequence 195.

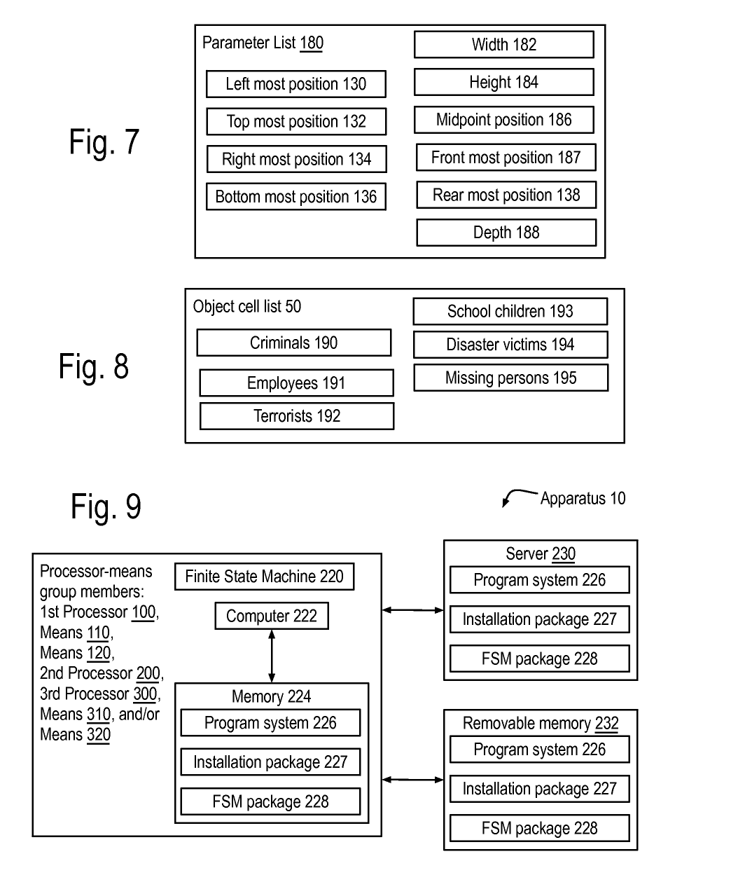

At least one of said realistic parameters 34 in said object schematic 40 may relate to a recognized feature 38 in a human face 26 and/or a human body 28. The recognized feature for the human face may be a member of a facial feature list shown through the example of FIG. 5. The recognized feature for the human body may be a member of a body feature list shown through the example of FIG. 6. And at least one of the realistic parameters related to the recognized feature may include at least one member of a parameter list shown through the example of FIG. 7.

FIG. 5 shows an example of the facial feature list 140 that may be used to identify the feature 38 found in the feature parameter 36. The facial feature list may include a left eye 142, a left eye brow 143, a left ear 144, a left jaw 146, a right eye 148, a right eye brow 149, a right ear 150, a right jaw 152, a chin 154, a nose 156, a mouth 158 and also the face 26. Note that the face 26 may be used to provide real world distances 32 such as its height as shown in FIG. 2.

FIG. 6 shows an example of the body feature list 160 that may include a left hand 161, a left forearm 162, a left arm 163, a left shoulder 164, a left breast 165, a left hip 166, a left shin 167, a left ankle 168, a left foot 169, a right hand 171, a right forearm 172, a right arm 173, a right shoulder 174, a right breast 175, a right hip 176, a right shin 177, a right ankle 178, a right foot 179, and the body 28.

FIG. 7 shows and example of the parameter list 180 that may include the left most position 130 as shown in FIG. 2, the top most position 132, the right most position 134 and the bottom most position 136, as well as a width 182, a height 184, a midpoint position 186, and when dealing with object schematics 30 in three dimensions, a front most position 187, a read most position 188 and a depth 189.

By way of example, some of the parameters may be derived from some of the other parameters.
The width 182 may be derived as the distance between the left most position 130 and the right most position 134. The height 184 may be derived as the distance between the top most position 132 and the bottom most position 136.
For object schematics 30 in two dimensions, the midpoint position 186 may be derived as the average of the left most position 130, the top most position 132, the right most position 134 and the bottom most position 136. In three dimensions, the midpoint position may be derived as the average of the left most position, the top most position, the right most position, the bottom most position, as well as the front most position 187 and the rear most position 138.
The depth 139 may be derived as a distance between the front most position 137 and the rear most position 138.

FIG. 8 shows the object cell list 50 containing object cells for at least one of criminals 190, employees 191, terrorists 192, school children 193, disaster victims 194, and/or missing persons 195.

FIG. 9 shows a number of embodiments of the apparatus 10, which may include at least one member of a processor-means group may comprise at least one instance of a finite state machine 220, a computer 222, and/or a memory 224 configured to be assessed by the computer. The memory 224 may include a program system and/or an installation package configured to instruct the computer to install the program system and/or a Finite State Machine (FSM) package 228 for configuring the FSM. The processor-means group may consist of the members of the first processor 100 of FIG. 1, the means 100 for scaling the item 20, the means 120 for analyzing the scaled item 26, the second processor 200, the third processor 300, the means 310 for selecting the matched object cell 56 from the object cell list 50, and the means 320 for assembling the matched cells.

The apparatus 10 may also include a server 230 configured to deliver to at least one of the processor-means group members the program system 226 and/or the installation package 227 and/or the FSM package 228.

The apparatus 10 may also include a removable memory 232 containing the program system 226 and/or the installation package 227 and/or the FSM package 228.

The installation package 227 may include source code that may be compiled and/or translated for use with the computer 222.

As used herein a processor 100, 200 and/or 300 may include at least one controller, where each controller receives at least one input maintains/updates at least one state and generates at least one output based at least one value of at least one the inputs and/or at least one of the states. A controller may implement a finite state machine 220 and/or a computer 222. A finite state machine may be implemented by any combination of at least one instance of a programmable logic device, such as a Field Programmable Gate Array (FPGA), a programmable macro-cell device and/or an array of memristors. A computer may include at least one data processor and at least one instruction processor, where each of the data processors is instructed by at least one instruction processor, and at least one of the instruction processors is instructed by a program system 226 including at least one program step residing in a computer readable memory 224 configured for accessible coupling to the computer. In certain situations the computer and the computer readable memory may reside in a single package, whereas in other situations they may reside in separate packages.

Other embodiments of the invention include program systems 226 for use in one or more of these three processors 100, 200, and 300 that provide the operations of these embodiments, and/or installation packages 227 to instruct the computer to install the program system, and/or FSM package 228 to configure the FSM to at least partly implement the operations of the invention. The installation packages and/or program systems are often referred to as software. The installation packages and/or the program systems may reside on the removable memory 232, on the server 230 configured to communicate with a client configuring one or more of these processors, in the client, and/or in the processor. The installation package may or may not include the source code configured to generate and/or alter the program system.

The FSM package 228, the installation package 227 and/or the program system 226 may be made available as a result of a login process, where the login process may be available only to subscribers of a service provided by a service provider, where the service provider receives revenue from a user of the processor 100, 200 and/or 300. The revenue is a product of the process of the user paying for the subscription and/or the user paying for the login process to download one of the packages and/or the program system. Alternatively, the user may pay for at least one instance of at least one of the processors creating a second revenue for a product supplier. The second revenue is a product of the user paying for the processor(s) from the product supplier.

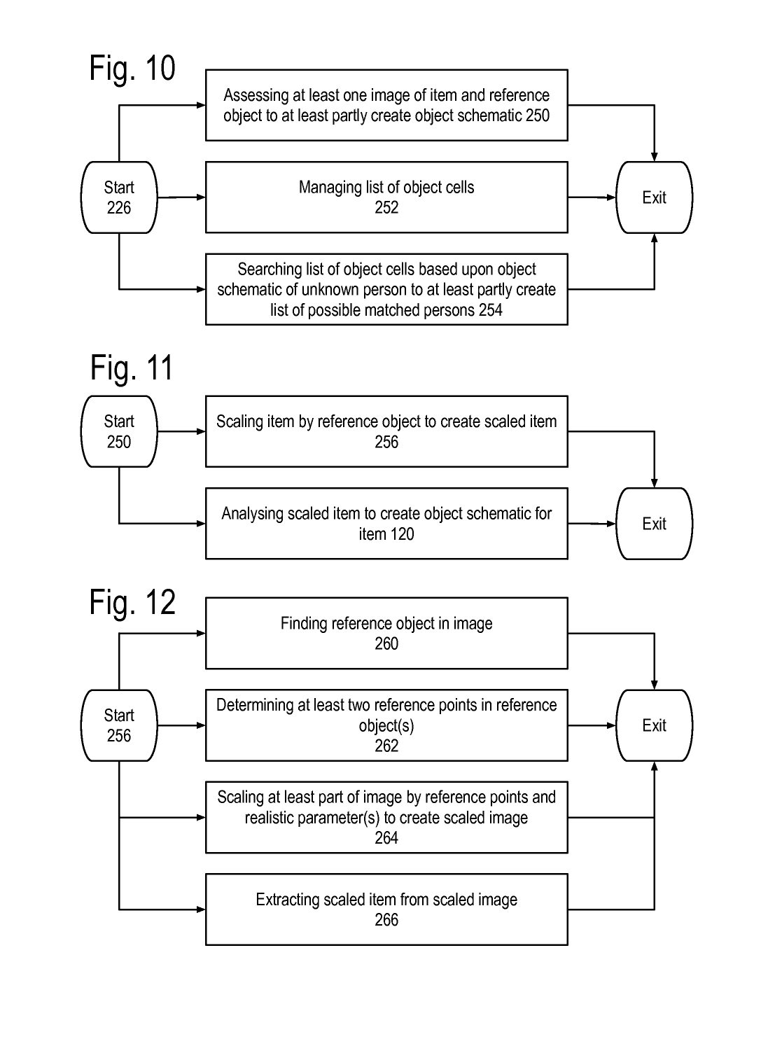

FIGS. 10 to 13 show some flowcharts of various methods of at least partly assessing the images 20, and/or managing the list 50 of object cells 52, and/or at least partly generating the list 62 of possible matched persons as first shown in FIG. 1.

FIG. 10 shows the program system 226 may include any combination of the following program steps. Program step 250 supports assessing at least one image 20 of the item 22 and at least one reference object 24 to at least partly create the object schematic 30. Program step 252 supports managing the list 50 of the object cells 52. And program step 254 supports searching the list of object cells based upon the second object schematic of the unknown person 60 to at least partly create the list 62 of possible matched persons.

FIG. 11 shows some details of program step 250 that support assessing the image to at least partly create the object schematic, which may include any combination of the following. Program step 256 supports scaling 110 the item 22 by the reference object 245 to create the scaled item 26. Program step 120 supports analyzing the scaled item to create the object schematic 30 for the item.

FIG. 12 shows some examples of the details of program step 256, which may include any combination of the following. Program step 260 supports finding at least one of the reference object 24 in the image 20. Program step 262 supports determining at least two reference points in the reference object, and a real distance between the reference points. Program step 264 supports scaling at least part of the image by the reference points and the realistic parameters(s) to create the scaled image. Program step 266 supports extracting the scaled item 26 from the scaled image.

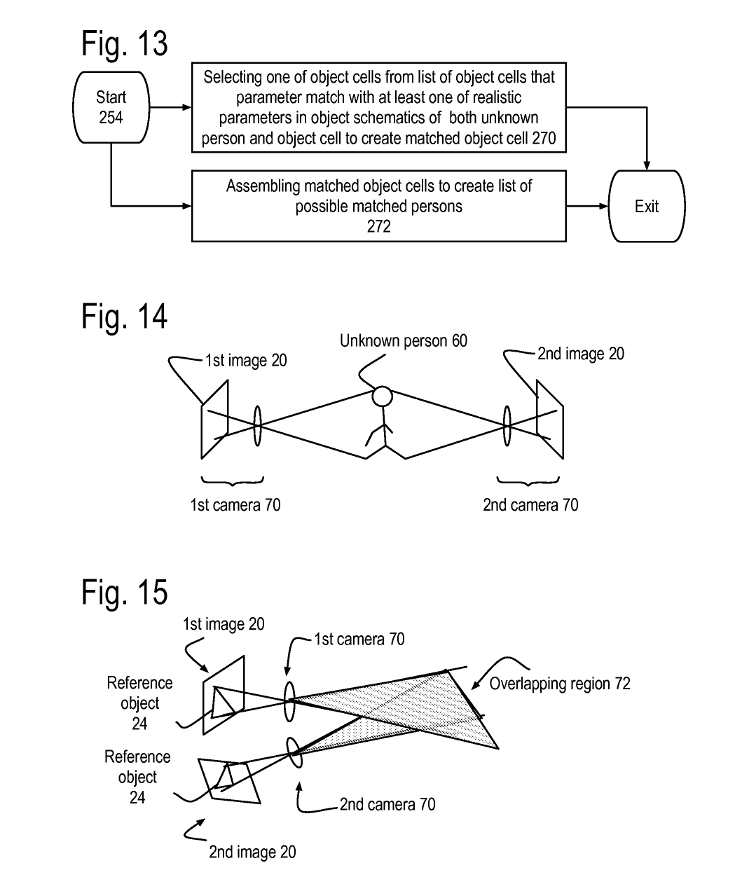

FIG. 13 shows some details of the program step 254 that support searching the list of object cells based upon the second object schematic of the unknown person to at least partly create the list of possible matched persons by including at least one of the following. Program step 280 supports selecting one of the object cells 52 from the object cell list 50 to create the matched object cell 56 having a parameter match with at least one of the recognized features 38 in both the object schematic 30 of the unknown person 60 and the object cell. Program step 272 supports assembling the matched object cells to create the list 62 of possible matched persons.

FIGS. 14 and 15 show some details of the use of multiple images 20 that may provide a scaled item 26 in three dimensions. Note that more than two images may be used and various correlation methods of either a statistical or method of least squares approach may be employed to improve the real world accuracy of the object schematic 30 being generated.

FIG. 14 shows a simplified schematic of the use of two images 20 of the unknown person 60 that may be taken by different cameras 70 that may be used to provide scaled item 26 and/or the object schematic 30 in three dimensions. Note that in some embodiments the person may be turned to provide profile views as in mug shots.

FIG. 15 shows a simplified schematic representation of the two cameras of FIG. 14 configured to have an overlapping region 72 that forms the reference objects 24 in the images 20. The distances may be generated from the pixel locations within these reference objects of the two images. Items 22 located in these reference objects can be scaled based upon their pixel positions through an inverse projection to the ones the cameras 70 implement.

Embodiments of this invention may also be used in one or more of the following situations:
to identify safe or unsafe people attempting to gain entry to sensitive locations such as attempting to board an airplane, enter a government building, enter a secured work facility.
to check for patient identity in hospitals to prevent dispensing incorrect prescriptions to the wrong patient.
at amusement parks, cruise ships, etc. to identify the customer and match it with vacation photos of that person for the purpose of selling that person or his or her family photos of them at the amusement park, ship, etc.
to speed registered passengers through airport security as proof of identification.
as proof of identity when cashing checks at banks or at stores or other locations.
as proof of identity at ATM machines when performing banking transactions.
as proof of identity when doing internet transactions by using a web base internet camera and scaling objects visible in the camera's line of sight.
to admit patrons to any paid event (sporting event, airplanes, trains, etc.) by comparing any know photo of the person (such as photo taken by a web camera when the tickets were purchased) to the photo of the person attempting to gain entry to the paid event.
as identification for people attempting stock trades or other financial transactions over the internet or in person.
to authorize drivers of cars. This can be used to prevent carjacking and only allow certain people to drive a car. It can also be used to prevent drunk driving such that if the car recognizes the driver as a person requiring a breath sample before they can drive while other people who do not have a drunk driving record won't be asked to present a breath sample.
to identify school children in school or to track missing children in public places.

The preceding embodiments provide examples of the invention, and are not meant to constrain the scope of the following claims.

What is claimed is:

1. An apparatus, comprising a processor configured to perform at least one of
assessing at least one image of an item and at least one reference object with at least one realistic parameter to at least partly create an object schematic including at least two realistic parameters, with each of said realistic parameters including at least one of a real world position and a real world distance,
managing a list of object cells, each comprising at least one instance of said object schematic and personal data, and
searching said list of object cells based upon a second of said object schematic of an unknown person to at least partly create a list of possible matched persons.

2. The apparatus of claim 1, wherein said item includes at least one member of the group consisting of a human face and a human body.

3. The apparatus of claim 2, wherein at least one of said realistic parameters in said object schematic relates to a recognized feature in at least one of a human face and a human body; and
wherein at least one of said realistic parameters related to said recognized feature includes at least one member of a parameter list of comprising instances of at least one of said real world position and said real world distance.

4. The apparatus of claim 3, wherein said processor configured to assess said at least one image is further configured to assess at least two of said images offset from each other to at least partly create said object schematic in three dimensions.

5. The apparatus of claim 4, wherein said reference object includes a shared field of view for said at least two images;
wherein the means for scaling said item by said reference object to create said scaled item further comprises means for scaling said item by a projection based upon said shared field of said view to create scaled item.

6. The apparatus of claim 1, wherein said processor is configured to perform at least two of
assessing said at least one image of said item and said reference object to at least partly create said object schematic,
managing said list of said object cells, and
searching said list of said object cells based upon said second of said object schematic to at least partly create said list of said possible matched persons.

7. The apparatus of claim 1,
wherein said processor configured to assess said at least one image of said item and said reference object to at least partly create said object schematic further comprises at least one of
means for scaling said item based upon said reference object to create a scaled item; and
means for analyzing said scaled item to create said object schematic;
wherein said processor configured to search said list of object cells based upon said second of said object schematic of said unknown person, further comprises at least one of
means for selecting one of said object cells from said list of said object cells having a parameter match with at least one of said features in both said second of said object schematic and said object cell to create a matched object cell, and
means for assembling said matched object cells to create said list of said possible matched persons.

8. The apparatus of claim 7, wherein a processor-means group consists of the members of said processor, said means for scaling said item, said means for analyzing said scaled item, said means for selecting said one of said object cells, and said means for assembling said matched object cells;
wherein at least one member of said processor-means group includes at least one instance of a member of the group consisting of
a Finite State Machine (FSM),
a computer,
a computer accessible memory including at least one of a program system, an installation package configured to instruct said computer to install said program system, and a FSM package for configuring said FSM.

9. A server configured to deliver to at least one of said members of said processor-means group of claim 8, at least one of said program system, said installation package, and said FSM package.

10. A removable memory, containing at least one of said program system of claim 8, said installation package, and said FSM package.

11. The program system of claim 8 further comprising at least one of the program steps of:
assessing said at least one image of said item and said reference object to at least partly create said object schematic;
scaling said item by said reference object to create said scaled item;
analyzing said scaled item to create said object schematic for said item;
managing said list of said object cells;
searching said list of object cells based upon said object schematic of said unknown person to at least partly create said list of said possible matched persons;
selecting one of said object cells from said list of said object cells having said parameter match with at least one of said features in both said object schematic of said unknown person and said object cell to create said matched object cell, and
assembling said matched object cells to create said list of said possible matched persons.

12. The program system of claim 11, wherein the program step of scaling further comprising the program steps of:
finding said at least one reference object in said image;
determining at least two reference points in said at least one reference object;
scaling at least part of said image by said reference points and said known realistic parameter to create a scaled image; and
extracting said scaled item from said scaled image.

13. A method, comprising at least one of the steps of:
assessing at least one image of an item and a reference object with at least one known realistic parameter to at least partly create an object schematic including at least two of said realistic parameters, with each of said realistic parameters including at least one of a real world position and a real world distance;
managing a list of object cells, each comprising at least one of said object schematic and a personal data; and
searching said list of object cells based upon said object schematic of an unknown person to create a list of possible matched persons.

14. The method of claim 13, with said step of assessing further comprising at least one of the steps of
scaling said item based upon said at least one reference object to create a scaled item, and
analyzing said scaled item to create said object schematic for said item;
wherein the step of searching said list of object cells, further comprises the at least one of the steps of:
selecting one of said object cells from said list of said object cells having a parameter match with at least one of said features in both said object schematic of said unknown person and said object cell to create a matched object cell; and
assembling said matched object cells to create said list of said possible matched persons.

15. The method of claim 14, wherein the step of scaling further comprises
finding said at least one reference object in said image;
determining at least two reference points based upon said at least one reference object and said at least one known realistic parameter;
scaling at least part of said image by said reference points and said at least one known realistic parameter to create a scaled image; and
extracting said scaled item from said scaled image.

16. The method of claim 13, wherein said item is at least one member of the group consisting of a human face and a human body.

17. The method of claim 16, wherein at least one of said realistic parameters in said object schematic relates to a recognized feature in at least one of a human face and a human body; and
wherein at least one of said realistic parameters related to said recognized feature includes at least one member of a parameter list of comprising instances of at least one of said real world position and said real world distance.

18. The method of claim 17, wherein the step of assessing said at least one image further comprises the step of
assessing at least two of said images offset from each other to at least partly create said object schematic in three dimensions.

19. The method of claim 18, wherein said reference object includes a shared field of view between said at least two images;
wherein the step scaling said item by said reference object to create said scaled item further comprises scaling said item by a projection based upon said shared field of said view to create scaled item.

20. The object schematic, the list of said object cells, and the list of said possible matched persons as the product of the process of claim 13.

21. The list of said object cells of claim 20, wherein said list refers to at least one of criminals, employees, terrorists, disaster victims, school children, and missing persons.
